(19) United States
(12) Patent Application Publication
(10) Pub. No.: US 2018/0231973 A1
(43) Pub. Date: Aug. 16, 2018

(54) System and Methods for a Virtual Reality Showroom with Autonomous Storage and Retrieval

(71) Applicant: Wal-Mart Stores, Inc., Bentonville, AR (US)

(72) Inventors: Todd Davenport Mattingly, Bentonville, AR (US); David G. Tovey, Rogers, AR (US)

(21) Appl. No.: 15/877,523

(22) Filed: Jan. 23, 2018

Related U.S. Application Data
(60) Provisional application No. 62/459,695, filed on Feb. 16, 2017.

(51) Int. Cl. G05D 1/00; G06T 19/00; G06F 3/01; B25J 9/16; G02B 27/01

(52) U.S. Cl. CPC G05D 1/0044; G06T 19/003; G02B 27/017; B25J 9/1689; B25J 9/162; G06F 3/011

(57) ABSTRACT

Described in detail herein are systems and methods for a virtual reality based fulfillment system. A virtual reality headset can render a 3D virtual simulation environment on including simulated representations of physical objects. The virtual reality headset receives a selection of the at least one of the simulated representations of the physical objects in response to detection of a user gesture. The virtual reality headset transmits a request to retrieve at least one of the selected physical objects from a facility. A computing system can instruct an autonomous robot device to retrieve the at least one of the physical objects. The autonomous robot device, autonomously retrieves and transports, the at least one of the physical objects to a specified location in the facility at which the user can retrieve the at least one of the physical objects.

### CROSS-REFERENCE TO RELATED PATENT APPLICATIONS

This application claims priority to U.S. Provisional Application No. 62/459,695 filed on Feb. 16, 2017, the content of which is hereby incorporated by reference in its entirety.

### BACKGROUND

It can be difficult to simulate physical objects in different environmental conditions. A facility may not have sufficient resources to generate a simulation environment.

### BRIEF DESCRIPTION OF DRAWINGS

Illustrative embodiments are shown by way of example in the accompanying drawings and should not be considered as a limitation of the present disclosure. The accompanying figures, which are incorporated in and constitute a part of this specification, illustrate one or more embodiments of the invention and, together with the description, help to explain the invention. In the figures:

FIG. 1 is a schematic diagram of an exemplary arrangement of physical objects disposed in a facility according to an exemplary embodiment;

FIG. 2A is a block diagram of a virtual reality headset configured to present a virtual third dimensional (3D) simulation environment according to an exemplary embodiment;

FIG. 2B is a schematic illustration of the virtual reality headset of FIG. 2A according to exemplary embodiments;

FIG. 2C illustrates a virtual 3D simulation environment rendered on a virtual headset in accordance with an exemplary embodiment;

FIG. 3 illustrates inertial sensors for interacting with a virtual 3D simulation environments in accordance with an exemplary embodiment;

FIG. 4 is a block diagram illustrating an autonomous robot device in a facility according to exemplary embodiments of the present disclosure;

FIG. 5 is a block diagrams illustrating another autonomous robot device in an autonomous system according to exemplary embodiments of the present disclosure;

FIG. 6 illustrates a smart shelf system according to exemplary embodiments of the present disclosure;

FIG. 7 illustrates an array of sensors in accordance with an exemplary embodiment;

FIG. 8 illustrates an exemplary virtual reality based fulfillment system in accordance with an exemplary embodiment;

FIG. 9 illustrates an exemplary computing device in accordance with an exemplary embodiment; and

FIG. 10 is a flowchart illustrating a process of the virtual reality based fulfillment system according to an exemplary embodiment.

### DETAILED DESCRIPTION

Described in detail herein are systems and methods for a virtual reality based autonomous fulfillment system. A virtual reality headset including inertial sensors can render a 3D virtual simulation environment on a display. The 3D virtual simulation environment includes simulated representations of physical objects, and the inertial sensors can detect user gestures corresponding to virtual interactions with the simulated representations of the physical objects. The virtual reality headset receives a selection of a simulated representation of one of the physical objects in response to detection of the user gestures, and transmits a request for retrieval of the physical object corresponding to the simulated representation. A computing system can receive the request, and can instruct an autonomous robot system to retrieve the physical object. The autonomous robot system determines a locations in a facility at which the physical object is disposed, and autonomously retrieves the physical object. The autonomous robot system transports the physical object to a specified location in the facility at which the user can retrieve the physical object.

Embodiments of the system can include a database operatively coupled to the computing system. The instructions from the computing system include one or more identifiers for physical objects selected via the simulated virtual 3D environment. The autonomous robot system is configured to query the database using the one or more identifiers for the selected physical objects to retrieve the one or more locations at which the selected physical objects is disposed. The autonomous robot system can include at least one autonomous robot device that is configured to navigate autonomously through the facility to the one or more locations in response to operation of a drive motor by a controller of the autonomous robot device, locate and scan one or more machine readable elements encoded with the one or more identifiers, detect, via an image captured by an image capture device of the autonomous robot device, that the at least one of the physical objects is disposed at the one or more locations and pick up a quantity of the selected physical objects using an articulated arm of the autonomous robot device.

The system can include shelving units disposed in the facility. The quantity of the selected physical objects can be disposed on the shelving units. A first group of sensors can be disposed on or about the of shelving units. The first group of sensors are configured to detect a change to a first set of attributes associated with the shelving units when the quantity of the selected physical objects is removed from the shelving units, and to transmit the first set of attributes to the computing system. The computing system updates the database in response to receiving the first set of attributes. The first set of attributes can include one or more of: moisture, weight, quantity or temperature.

A storage container is disposed at the specified location and the autonomous robot system is configured to deposit the retrieved set of physical objects in the storage container. The autonomous robot system can be configured to transport the storage container to the user of the virtual reality headset.

The system further includes a controller configured to be held or worn on a hand of the user. The controller can include a group of sensors, wherein the user can interact with the controller to interact with or select the simulated representations of the physical objects in the 3D virtual simulation environment. The virtual reality headset is configured to generate sensory feedback based on a first set of sensory attributes associated with the physical object in response to executing the first action in the 3D virtual simulation environment. The virtual reality headset is further configured to render the 3D virtual simulation environment including the physical object and additional physical objects associated with one of the physical object on the display, detect a second user gesture using the inertial sensors. The second user gesture can correspond to an interaction between the user and the 3D virtual simulation environment. The virtual reality headset can execute a second action in the 3D virtual simulation environment based on the second user gesture to provide a demonstrable property or function of the additional physical objects and generate sensory feedback based on a second set of sensory attributes associated with the additional physical objects in response to executing the second action in the 3D virtual simulation environment.

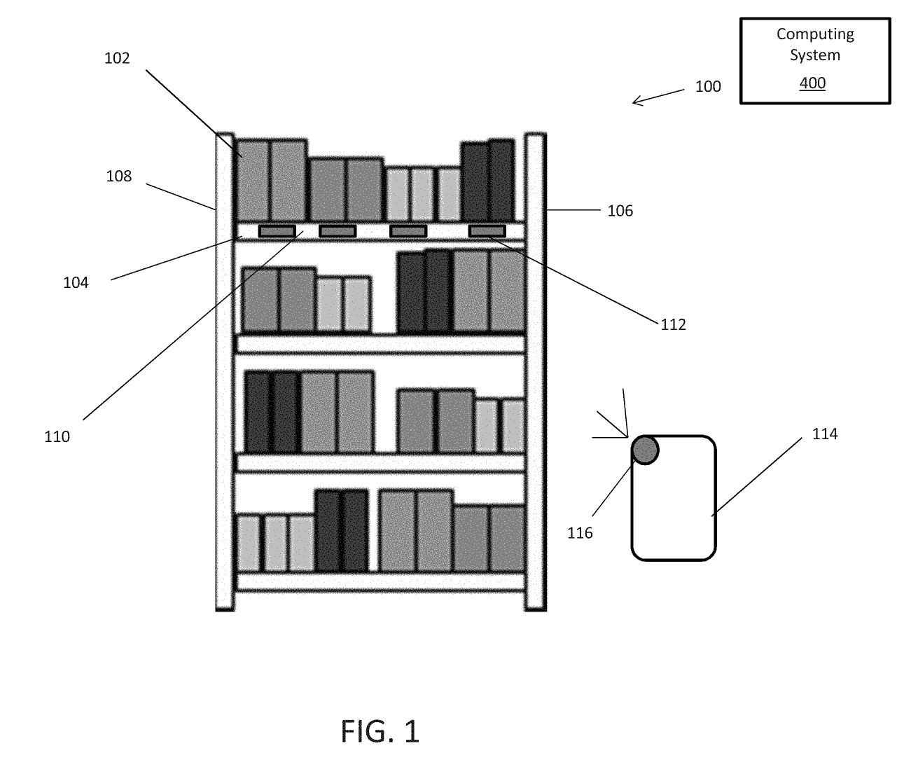

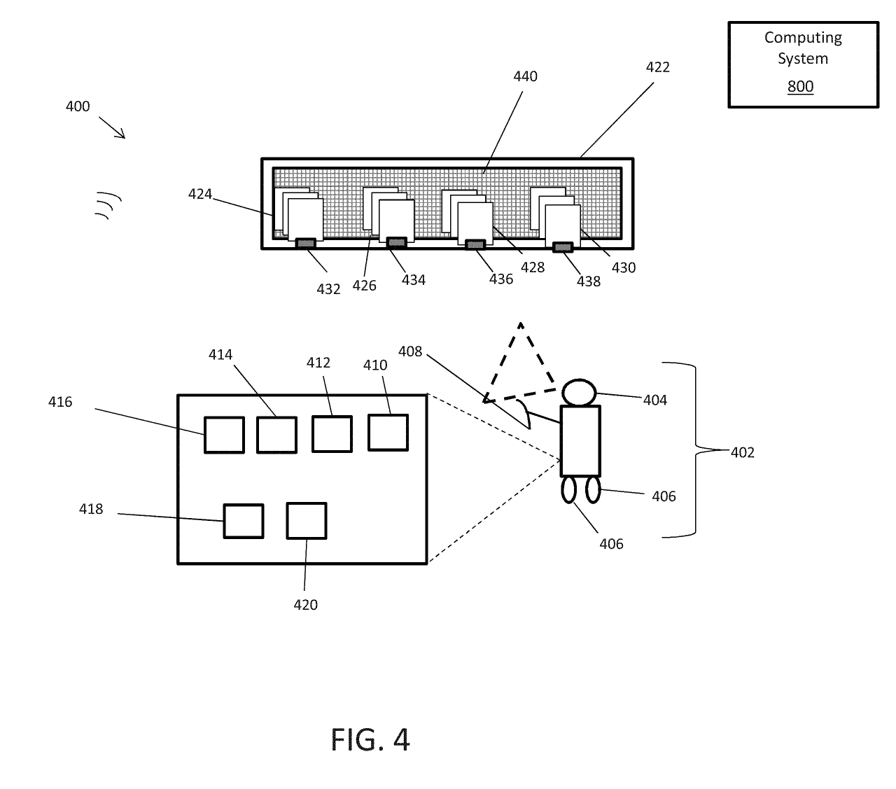

FIG. 1 is a schematic diagram of an exemplary arrangement physical objects disposed in a facility according to an exemplary embodiment. A shelving unit 100 can include several shelves 104 holding physical objects 102. The shelves 104 can include a top or supporting surface extending the length of the shelf 104. The shelves 104 can also include a front face 110. Labels 112, including machine-readable elements, can be disposed on the front face 110 of the shelves 104. The machine-readable elements can be encoded with identifiers associated with the physical objects disposed on the shelves 104. The machine-readable elements can be barcodes, QR codes, RFID tags, and/or any other suitable machine-readable elements. A device 114 (i.e. mobile device) including an reader 116 (e.g., an optical scanner or RFID reader) can be configured to read and decode the identifiers from the machine-readable elements. The device 114 can communicate the decoded identifiers to a computing system. An example computing system is described in further detail with reference to FIG. 4.

In some embodiments, images of the physical objects and machine-readable elements disposed with respect to the images can be presented to a user (e.g., such that the actual physical object is not readily observable by the user. The user can scan the machine-readable elements using the device 114 including the reader 116. In another embodiment, the images of physical objects can be presented via a virtual reality headset and a user can select an image of a physical objects by interacting with the virtual reality headset as will be described herein.

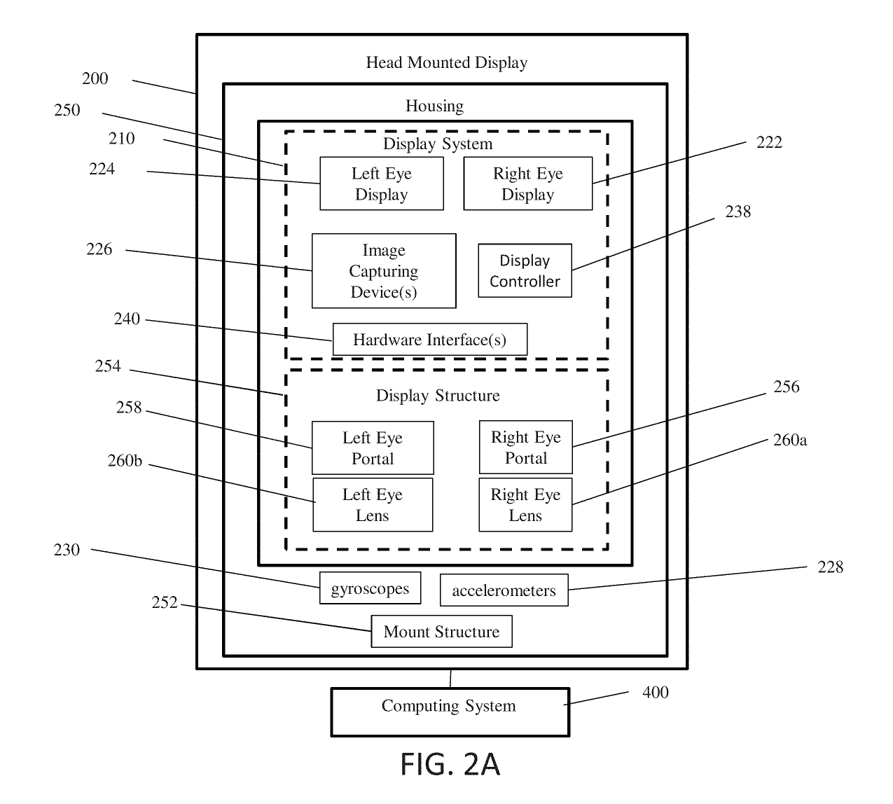

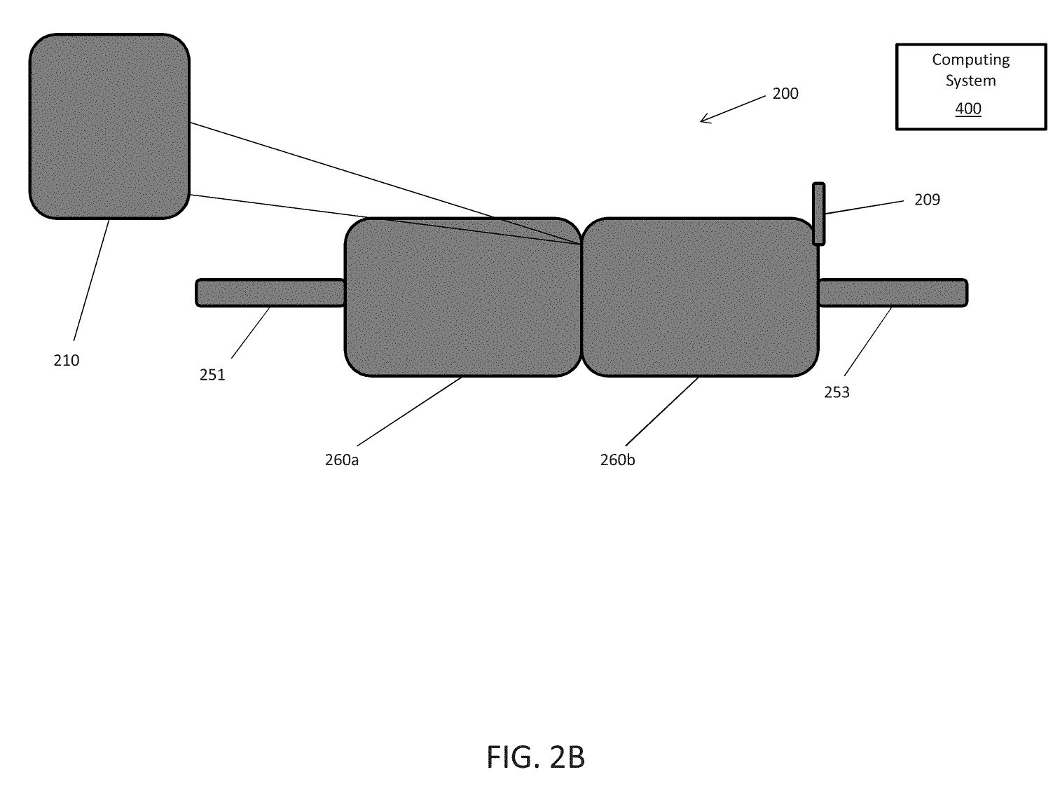

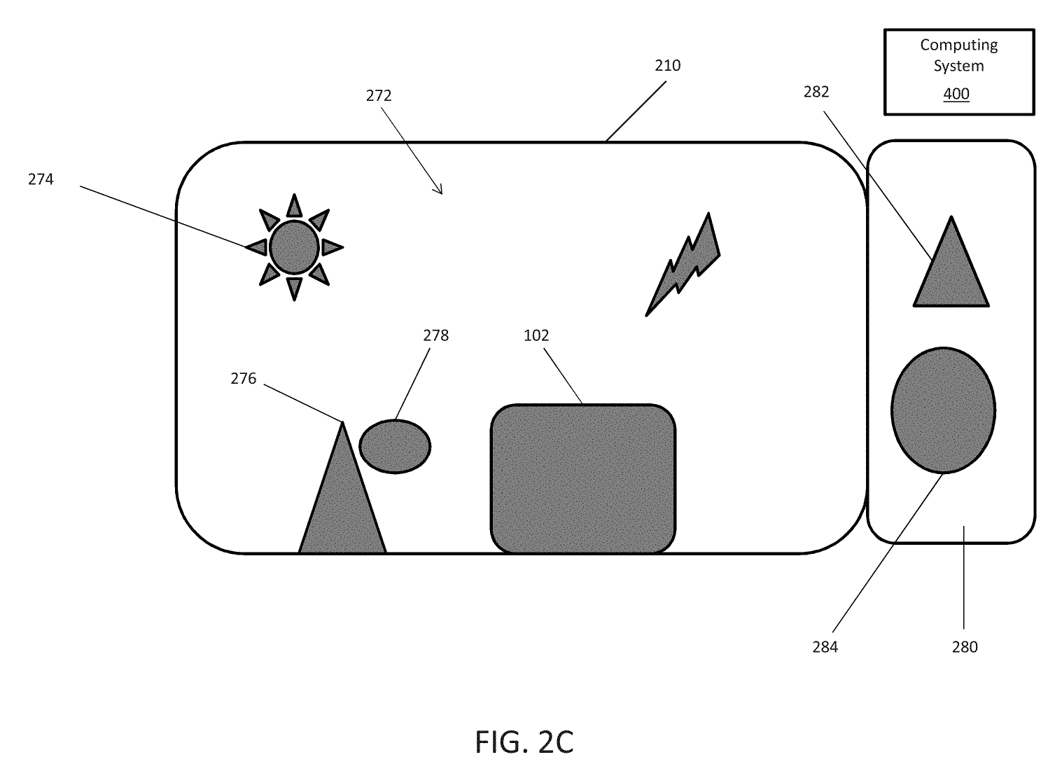

FIGS. 2A-B illustrate a virtual reality headset 200 for presenting a virtual 3D simulation environment according to an exemplary embodiment. The virtual reality headset 200 can be a head mounted display (HMD). The virtual reality headset 200 and the computing system 400 can be communicatively coupled to each other via wireless or wired communications such that the virtual reality headset 200 and the computing system 400 can interact with each other to implement the 3D virtual simulation environment. The computing system 400 will be discussed in further details with reference to FIG. 4.

The virtual reality headset 200 can include circuitry disposed within a housing 250. The circuitry can include a display system 210 having a right eye display 222, a left eye display 224, one or more image capturing devices 226, one or more display controllers 238 and one or more hardware interfaces 240. The display system 210 can display a 3D virtual simulation environment.

The right and left eye displays 222 and 224 can be disposed within the housing 250 such that the right display is positioned in front of the right eye of the user when the housing 250 is mounted on the user's head and the left eye display 224 is positioned in front of the left eye of the user when the housing 250 is mounted on the user's head. In this configuration, the right eye display 222 and the left eye display 224 can be controlled by one or more display controllers 238 to render images on the right and left eye displays 222 and 224 to induce a stereoscopic effect, which can be used to generate three-dimensional images. In exemplary embodiments, the right eye display 222 and/or the left eye display 224 can be implemented as a light emitting diode display, an organic light emitting diode (OLED) display (e.g., passive-matrix (PMOLED) display, active-matrix (AMOLED) display), and/or any suitable display.

In some embodiments the display system 210 can include a single display device to be viewed by both the right and left eyes. In some embodiments, pixels of the single display device can be segmented by the one or more display controllers 238 to form a right eye display segment and a left eye display segment within the single display device, where different images of the same scene can be displayed in the right and left eye display segments. In this configuration, the right eye display segment and the left eye display segment can be controlled by the one or more display controllers 238 disposed in a display to render images on the right and left eye display segments to induce a stereoscopic effect, which can be used to generate three-dimensional images.

The one or more display controllers 238 can be operatively coupled to right and left eye displays 222 and 224 (or the right and left eye display segments) to control an operation of the right and left eye displays 222 and 224 (or the right and left eye display segments) in response to input received from the computing system 400 and in response to feedback from one or more sensors as described herein. In exemplary embodiments, the one or more display controllers 238 can be configured to render images on the right and left eye displays (or the right and left eye display segments) of the same scene and/or objects, where images of the scene and/or objects are render at slightly different angles or points-of-view to facilitate the stereoscopic effect. In exemplary embodiments, the one or more display controllers 238 can include graphical processing units.

The headset 200 can include one or more sensors for providing feedback used to control the 3D environment. For example, the headset can include image capturing devices 226, accelerometers 228, gyroscopes 230 in the housing 250 that can be used to detect movement of a user's head or eyes. The detected movement can be used to form a sensor feedback to affect 3D virtual simulation environment. As an example, if the images captured by the camera indicate that the user is looking to the left, the one or more display controllers 238 can cause a pan to the left in the 3D virtual simulation environment. As another example, if the output of the accelerometers 228 and/or gyroscopes 230 indicate that the user has tilted his/her head up to look up, the one or more display controllers can cause a pan upwards in the 3D virtual simulation environment.

The one or more hardware interfaces 240 can facilitate communication between the virtual reality headset 200 and the computing system 400. The virtual reality headset 200 can be configured to transmit data to the computing system 400 and to receive data from the computing system 400 via the one or more hardware interfaces 240. As one example, the one or more hardware interfaces 240 can be configured to receive data from the computing system 400 corresponding to images and can be configured to transmit the data to the one or more display controllers 238, which can render the images on the right and left eye displays 222 and 224 to provide a 3D simulation environment in three-dimensions (e.g., as a result of the stereoscopic effect) that is designed to facilitate vision therapy for binocular dysfunctions Likewise, the one or more hardware interfaces 240 can receive data from the image capturing devices corresponding to eye movement of the right and left eyes of the user and/or can receive data from the accelerometer 228 and/or the gyroscope 230 corresponding to movement of a user's head. and the one or more hardware interfaces 240 can transmit the data to the computing system 400, which can use the data to control an operation of the 3D virtual simulation environment.

The housing 250 can include a mounting structure 252 and a display structure 254. The mounting structure 252 allows a user to wear the virtual reality headset 200 on his/her head and to position the display structure over his/her eyes to facilitate viewing of the right and left eye displays 222 and 224 (or the right and left eye display segments) by the right and left eyes of the user, respectively. The mounting structure can be configured to generally mount the virtual reality headset 200 on a user's head in a secure and stable manner. As such, the virtual reality headset 200 generally remains fixed with respect to the user's head such that when the user moves his/her head left, right, up, and down, the virtual reality headset 200 generally moves with the user's head.

The display structure 254 can be contoured to fit snug against a user's face to cover the user's eyes and to generally prevent light from the environment surrounding the user from reaching the user's eyes. The display structure 254 can include a right eye portal 256 and a left eye portal 258 formed therein. A right eye lens 260a can be disposed over the right eye portal and a left eye lens 260b can be disposed over the left eye portal. The right eye display 222, the one or more capturing devices 226 behind the lens 260a of the display structure 254 covering the right eye portal 256 such that the lens 256 is disposed between the user's right eye and each of the right eye display 222 and the one or more right eye image capturing devices 226. The left eye display 224 and the one or more image capturing devices 228 can be disposed behind the lens 260b of the display structure covering the left eye portal 258 such that the lens 260b is disposed between the user's left eye and each of the left eye display 224 and the one or more left eye image capturing devices 228.

The mounting structure 252 can include a left band 251 and right band 253. The left and right band 251, 253 can be wrapped around a user's head so that the right and left lens are disposed over the right and left eyes of the user, respectively. The virtual reality headset 200 can include one or more inertial sensors 209 (e.g., the accelerometers 228 and gyroscopes 230). The inertial sensors 209 can detect movement of the virtual reality headset 200 when the user moves his/her head. The virtual reality headset 200 can adjust the 3D virtual simulation environment based on the detected movement output by the one or more inertial sensors 209. The accelerometers 228 and gyroscope 230 can detect attributes such as the direction, orientation, position, acceleration, velocity, tilt, pitch, yaw, and roll of the virtual reality headset 200. The virtual reality headset 200 can adjust the 3D virtual simulation environment based on the detected attributes. For example, if the head of the user turns to the right the virtual reality headset 200 can render the 3D simulation environment to pan to the right.

FIG. 2C is a block diagram of a virtual reality headset presenting a virtual 3D simulation environment 272 according to an exemplary embodiment. The 3D virtual simulation environment 272 can include a representation of the physical object 102 associated with the machine-readable element scanned by the reader as described in FIG. 1. The 3D virtual simulation environment 272 can also include representations of physical objects 276, 278 associated with the physical object 102. The 3D virtual simulation environment 212 can include various environmental factors 274 such as weather simulations, nature simulations, interior simulations, or any other suitable environment factors. For example, in the event the physical objects 102, 276, and 278 represented in the 3D virtual simulation environment 272 are tools to be used outside, the 3D virtual simulation environment can simulate various types of weather conditions such as heat, rain or snow. The representations of the physical objects 102, 276 and 278 can be responsive to the environmental conditions by simulating changing physical properties or function of the representations of the physical objects 102, 276, and 278, such as a size, a shape, dimensions, moisture, a temperature, a weight and/or a color.

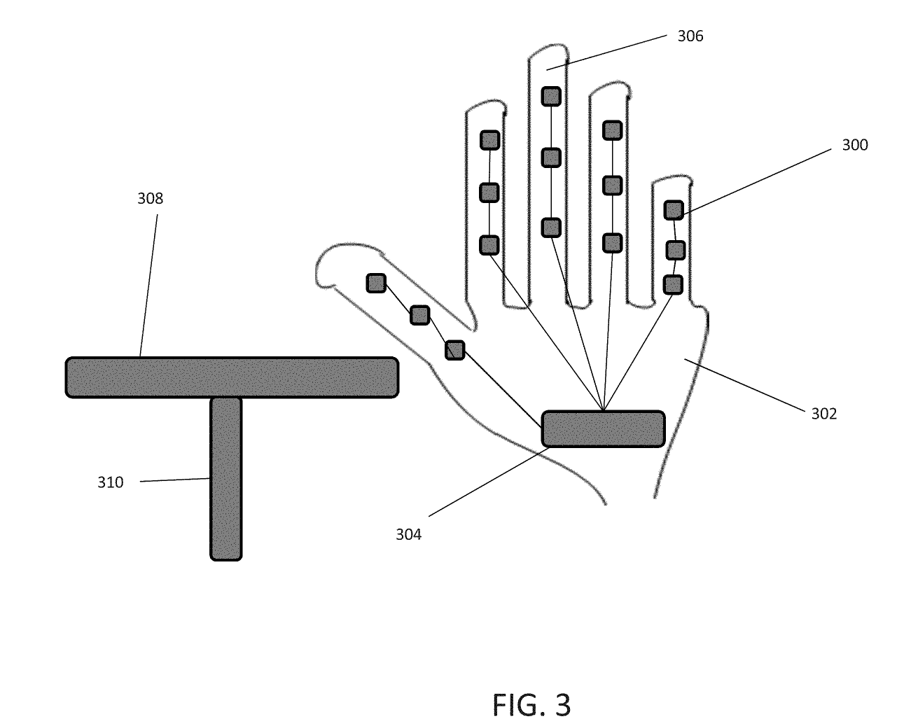

A user can interact with the 3D virtual simulation environment 272. For example, the user can view the physical objects 102, 276, 278 at different angles by moving their head and in turn moving the virtual reality headset. The output of the inertial sensors as described in FIG. 2A-B can cause the virtual reality headset to move the view of the 3D virtual simulation environment 272 so the user can view the physical objects 102, 276, 278, at different angles and perspectives based on the detected movement. The user can also interact with the 3D virtual simulation environment 272 using sensors disposed on their hands (e.g., in gloves) as described herein with respect to FIG. 3.

In some embodiments, a side panel 280 can be rendered in the 3D virtual simulation environment 272. The side panel 280 can display additional physical objects 282 and 284. A user can select representations of one or more of the physical objects 282 or 284 to be included into or excluded from the 3D virtual simulation environment 272. When two or more physical objects are being represented in the 3D virtual simulation environment 272, the 3D simulation environment can simulate an interaction between the representations of the two or more physical objects (e.g., to simulate how the two or more physical objects function together and/or apart, to simulate how the two or more physical objects look together, to simulate differences in the function or properties of the two or more physical objects).

FIG. 3 illustrates inertial sensors 300 in accordance with an exemplary embodiment. The inertial sensors 300 can be disposed on a user's hand 302 (e.g., in a glove or other wearable device). The inertial sensors 300 can be disposed throughout the digits 306 of the user's hand 302 to sense the movement of each digit separately. The inertial sensors 300 can be coupled to a controller 304. The inertial sensors 300 can detect motion of the user's hand 302 and digits 306 and can output the detected motion to the controller 304, which can communicate the motion of the user's hand 302 and digits 306 to the virtual reality headset and/or the computing system. The virtual reality headset can be configured to adjust the 3D virtual simulation environment rendered by the display system in response to the detected movement of the user's hand 302 and digits 306. For example, the user can interact with the representations of the physical objects within the 3D virtual simulation based on the motion of their hands 302 and digits 306. For example, a user can pick up, operate, throw, squeeze or perform other actions with their hands and the physical objects. It can be appreciated the inertial sensors 300 can be placed on other body parts such as feed and/or arms to interact with the physical objects within 3D virtual simulation environment.

The user can also receive sensory feedback associated with interacting with the physical objects in the 3D virtual simulation environment. The user can receive sensory feedback using sensory feedback devices such as the bars 308 and 310. The user can grab the bars 308 and/or 310 and the virtual reality headset can communicate the sensory feedback through the bars 308, 310. The sensory feedback can include attributes associated with the physical object in a stationary condition and also the physical objects responsiveness to the environment created in the 3D virtual simulation environment and/or an operation of the physical object in varying conditions. The sensory feedback can include one or more of: weight, temperature, shape, texture, moisture, smell, force, resistance, mass, density and size. In some embodiments, the inertial sensors 300 can be also embodied as the sensory feedback devices.

FIG. 4 is a block diagram illustrating an autonomous robot device in an autonomous robot fulfillment system according to exemplary embodiments of the present disclosure. In exemplary embodiments, an autonomous robot system can be instructed to retrieve physical objects from a facility 400 in response to an interaction between the user and the 3D virtual simulation environment, e.g., when a user selects a simulated representation of a physical object in the 3D virtual simulation environment, the autonomous robot device can be instructed to retrieve the physical object corresponding to the selected simulated representation in the 3D virtual simulation environment. The autonomous robot system can include autonomous robot devices, such as a driverless vehicle, an unmanned aerial craft, automated conveying belt or system of conveyor belts, and/or the like. Embodiments of one of the autonomous robot devices—i.e. autonomous robot device 402—can include an image capturing device 404, motive assemblies 406, a picking unit 408, a controller 410, an optical scanner 412, a drive motor 414, a GPS receiver 416, accelerometer 418, and a gyroscope 420, and can be configured to roam autonomously through the facility 400. The picking unit 408 can be an articulated arm. The autonomous robot device 402 can be an intelligent device capable of performing tasks without human control. The controller 410 can be programmed to control an operation of the image capturing device 404, the optical scanner 412, the drive motor 414, the motive assemblies 406 (e.g., via the drive motor 414), in response to various inputs including inputs from the image capturing device 404, the optical scanner 412, the GPS receiver 416, the accelerometer 418, and the gyroscope 420. The drive motor 414 can control the operation of the motive assemblies 406 directly and/or through one or more drive trains (e.g., gear assemblies and/or belts). In this non-limiting example, the motive assemblies 406 are wheels affixed to the bottom end of the autonomous robot device 402. The motive assemblies 406 can be but are not limited to wheels, tracks, rotors, rotors with blades, and propellers. The motive assemblies 406 can facilitate 360 degree movement for the autonomous robot device 402. The image capturing device 404 can be a still image camera or a moving image camera.

The GPS receiver 416 can be a L-band radio processor capable of solving the navigation equations in order to determine a position of the autonomous robot device 402, determine a velocity and precise time (PVT) by processing the signal broadcasted by GPS satellites. The accelerometer 418 and gyroscope 420 can determine the direction, orientation, position, acceleration, velocity, tilt, pitch, yaw, and roll of the autonomous robot device 402. In exemplary embodiments, the controller can implement one or more algorithms, such as a Kalman filter, for determining a position of the autonomous robot device.

Sets of physical objects 424-430 can be disposed in a facility 400 on a shelving unit 422, where each set of like physical objects 424-430 can be grouped together on the shelving unit 42. The physical objects in each of the sets can be associated with identifiers encoded in a machine-readable element 432-438 corresponding to the physical objects in the sets 424-430 accordingly, where like physical object can be associated with identical identifiers and disparate physical objects can be associated with different identifiers. The machine readable elements 432-438 can be barcodes or QR codes.

Sensors 440 can be disposed on the shelving unit 422. The sensors 440 can include temperature sensors, pressure sensors, flow sensors, level sensors, proximity sensors, biosensors, image sensors, gas and chemical sensors, moisture sensors, humidity sensors, mass sensors, force sensors and velocity sensors. At least one of the sensors 440 can be made of piezoelectric material as described herein. The sensors 440 can be configured to detect a set of attributes associated with the physical objects in the sets of like physical objects 124-430 disposed on the shelving unit 422. The set of attributes can be one or more of: quantity, weight, temperature, size, shape, color, object type, and moisture attributes.

As mentioned above, the autonomous robot device 402 can receive instructions to retrieve physical objects from the sets of like physical objects 424-430 from the facility 400 in response to selection of simulated representations of the physical objects 424-430 by a user via the 3D virtual simulation environment. For example, the autonomous robot device 402 can receive instructions to retrieve a specified quantity of physical objects from the sets of like physical objects 424 and 428. The instructions can include identifiers associated with the sets of like physical objects 424 and 428. The autonomous robot device 402 can query a database to retrieve the designated location of the set of like physical objects 124 and 428. The autonomous robot device 402 can navigate through the facility 400 using the motive assemblies 406 to the set of like physical objects 424 and 428. The autonomous robot device 402 can be programmed with a map of the facility 400 and/or can generate a map of the first facility 400 using simultaneous localization and mapping (SLAM). The autonomous robot device 402 can navigate around the facility 400 based on inputs from the GPS receiver 416, the accelerometer 418, and/or the gyroscope 420.

Subsequent to reaching the designated location(s) of the set of like physical objects 424 and 428, the autonomous robot device 402 can use the optical scanner 412 to scan the machine readable elements 432 and 436 associated with the set of like physical objects 424 and 428 respectively. In some embodiments, the autonomous robot device 402 can capture an image of the machine-readable elements 432 and 436 using the image capturing device 404. The autonomous robot device 402 can extract the machine readable element from the captured image using video analytics and/or machine vision.

The autonomous robot device 402 can extract the identifier encoded in each machine readable element 432 and 436. The identifier encoded in the machine readable element 432 can be associated with the set of like physical objects 424 and the identifier encoded in the machine readable element 436 can be associated with the set of like physical objects 428. The autonomous robot device 402 can compare and confirm the identifiers received in the instructions are the same as the identifiers decoded from the machine readable elements 432 and 436. The autonomous robot device 402 can capture images of the sets of like physical objects 424 and 428 and can use machine vision and/or video analytics to confirm the set of like physical objects 424 and 428 are present on the shelving unit 422. The autonomous robot device 402 can also confirm the set of like physical objects 424 and 428 include the physical objects associated with the identifiers by comparing attributes extracted from the images of the set of like physical objects 424 and 428 in the shelving unit and stored attributes associated with the physical objects 428 and 428.

The autonomous robot device 402 can pick up a specified quantity of physical objects from each of the sets of like physical objects 424 and 428 from the shelving unit 522 using the picking unit 408. The picking unit 408 can include a grasping mechanism to grasp and pickup physical objects. The sensors 440 can detect when a change in a set of attributes regarding the shelving unit 422 in response to the autonomous robot device 402 picking up the set of like physical objects 424 and 428. For example, the sensors can detect a change in quantity, weight, temperature, size, shape, color, object type, and moisture attributes. The sensors 440 can detect the change in the set of attributes in response to the change in the set of attributes being greater than a predetermined threshold. The sensors 440 can encode the change in the set of attributes into electrical signals. The sensors can transmit the electrical signals to a computing system.

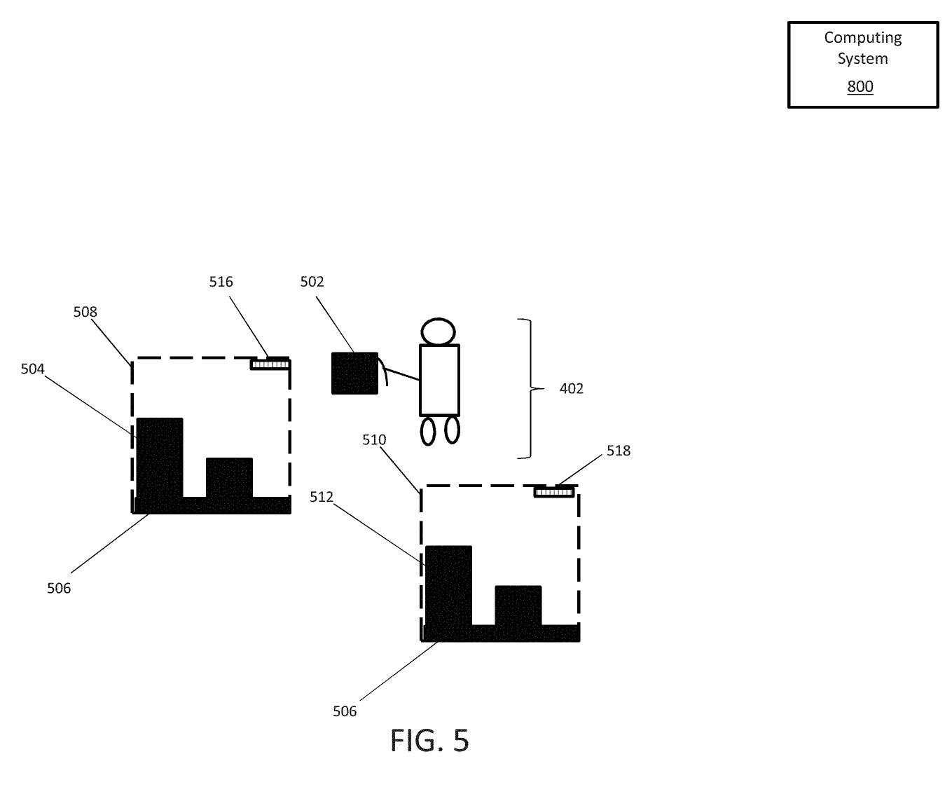

FIG. 5 is a block diagrams illustrating an embodiment of the autonomous robot device 402 in a facility according to exemplary embodiments of the present disclosure. As mentioned above, the autonomous robot device 402 can transport physical objects 502 to a different location in the facility and/or can deposit the physical objects on an autonomous conveyor belt or system of conveyor belts to transport the physical objects 502 to a different location. The different location can include storage containers 508 and 510. Machine-readable elements 516 and 518 can be disposed on the storage containers 508 and 510 respectively. The machine-readable elements 516 and 518 can be encoded with identifiers associated with the storage containers 508 and 510. The storage container 508 can store physical objects 504 and the storage container 510 can store physical objects 512. The storage containers 508 and 510 can also include sensors 506 disposed in the storage containers 508 and 510 (e.g., at a base of the storage containers 508 and 510). The sensors 506 can include temperature sensors, pressure sensors, flow sensors, level sensors, proximity sensors, biosensors, image sensors, gas and chemical sensors, moisture sensors, humidity sensors, mass sensors, force sensors and velocity sensors. The physical objects 504 and 512 can be placed in proximity to and/or on top of the sensors 506. In some embodiments, a least one of the sensors 506 can be made of piezoelectric material as described herein. The sensors 506 can be configured to detect a set of attributes associated with the physical objects 504 and 512 disposed in the storage containers 508 and 510, respectively. The set of attributes can be one or more of: quantity, weight, temperature, size, shape, color, object type, and moisture attributes. The sensors can transmit the detected set of attributes to a computing system.

The autonomous robot device 402 can receive instructions to retrieve physical objects 502, which can also include an identifier of the storage container in which the autonomous robot device 402 should place the physical objects 502. The autonomous robot device 402 can navigate to the storage containers 508 and 510 with the physical objects 502 and scan the machine readable element 516 and 518 for the storage containers 508 and 510. The autonomous robot device 402 extract the identifiers from the machine readable elements 516 and 518 and determine in which storage container to place the physical objects 502. For example, the instructions can include an identifier associated with the storage container 508. The autonomous robot device 402 can determine from the extracted identifiers to place the physical objects 502 in the storage container 508. In another embodiment, the storage containers 508 and 510 can be scheduled for delivery. The instructions can include an address(es) to which the storage containers are being delivered. The autonomous robot device 402 can query a database to determine the delivery addresses of the storage containers 508 and 510. The autonomous robot device 402 can place the physical objects 502 in the storage container with a delivery address corresponding to the address included in the instructions. Alternatively, the instructions can include other attributes associated with the storage containers 508 and 510 by which the autonomous robot device 402 can determine the storage container 508 or 510 in which to place the physical objects 502. The autonomous robot device 402 can also be instructed to place a first quantity of physical objects 502 in the storage container 508 and a second quantity of physical objects 502 in storage container 510.

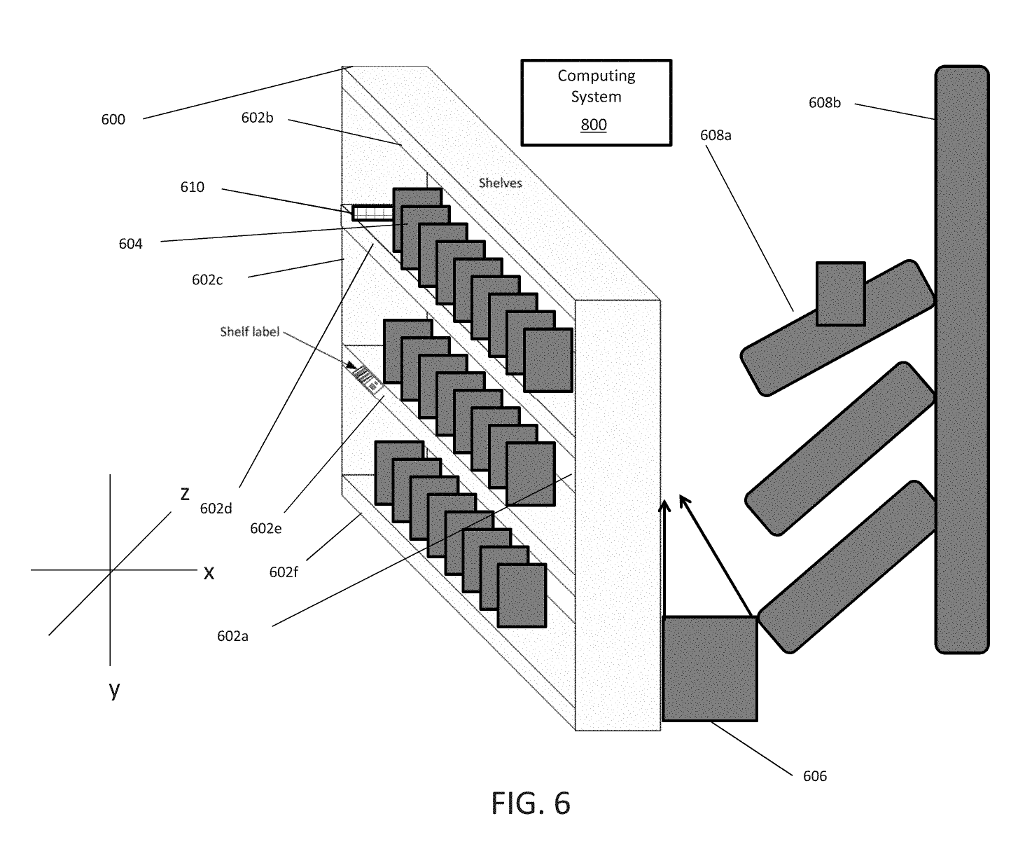

FIG. 6 illustrates an smart shelf system according to exemplary embodiments of the present disclosure. In some embodiments, the autonomous robotic system can be a smart shelf system that includes a shelving unit 600 including multiple edges 602a-f. Physical objects 604 can be disposed on the shelving unit 600. An autonomous retrieval container 606 affixed or disposed in proximity to a shelving unit 600, and one or more conveyer belts 608a-b disposed in front of or behind the shelving unit 600. The conveyer belts 608a can be disposed with respect to different sections of the shelving unit 600. The conveyer belt 608b can be disposed adjacent to the conveyer belt 608a. Physical objects 604 can be disposed on the shelving unit 600. The retrieval container 606 can receive instructions to retrieve one or more physical objects from the shelving unit 600 based on selections of simulated representations corresponding to the one or more physical object received via the 3D virtual simulation environment. The instructions can include the locations of the physical objects on the shelving unit 600. The autonomous retrieval container 606 can autonomously navigate along the edges 178 a-f of the shelving unit 600 and retrieve the instructed physical objects 604 based on the locations in the instructions. The autonomous retrieval container 606 can navigate along the x and y axis. The autonomous retrieval container 606 can include a volume in which to store the retrieved physical objects.

Sensors 610 can be disposed on or about the shelving unit 600. The sensors 610 can detect when a change in a set of attributes regarding the shelving unit 600 in response to the autonomous retrieval container 606 retrieving the instructed physical objects. For example, the sensors 610 can detect a change in quantity, weight, temperature, size, shape, color, object type, and moisture attributes. The sensors 610 can detect the change in the set of attributes in response to the change in the set of attributes being greater than a predetermined threshold. The sensors 610 can encode the change in the set of attributes into electrical signals. The sensors can transmit the electrical signals to a computing system.

The autonomous retrieval container 606 can receive instructions to retrieve physical objects 604 from the shelving unit 600 in response to selection of simulated representations in the 3D virtual simulation environment corresponding to the physical objects 604. In exemplary embodiments, an autonomous retrieval system can be instructed to retrieve physical objects from a facility in response to an interaction between the user and the 3D virtual simulation environment, e.g., when a user selects a simulated representation of a physical object in the 3D virtual simulation environment, the autonomous robot device can be instructed to retrieve the physical object corresponding to the selected simulated representation in the 3D virtual simulation environment. The instructions can include the locations of the physical objects 604 on the shelving unit 600. The autonomous retrieval container can traverse along the edges 602a-f of the shelving unit and retrieve the physical objects. The autonomous retrieval container 606 can place the physical objects on the conveyer belt 608a disposed behind the shelving unit 600. The conveyer belts 608a can receive instructions to transport physical objects to the conveyer belt 608b disposed adjacent to the conveyer belt 608a. The conveyer belt 608b can receive instructions to transport the physical objects to a specified location in a facility such as a delivery vehicle or a loading area.

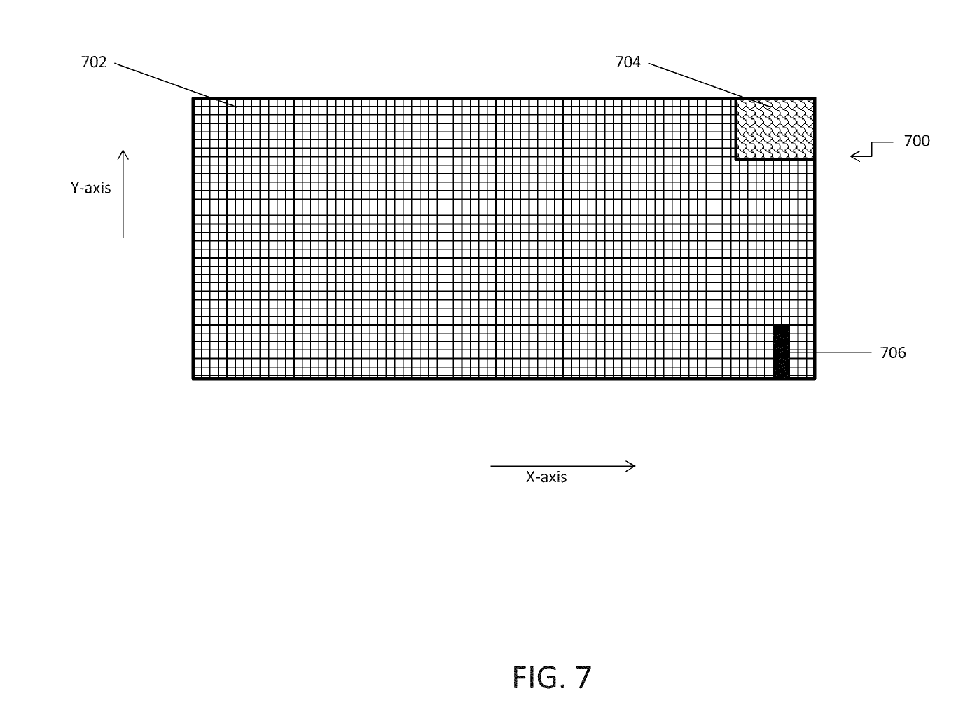

FIG. 7 illustrates an array of sensors 700 in accordance with an exemplary embodiment. The array of sensors 700 can be disposed at the shelving units (e.g., embodiments of the shelving unit 422 and 174 shown in FIGS. 4 and 6) and/or base of the storage containers (e.g., embodiments of the containers 508 and 510 shown in FIG. 5). The array of sensors 700 may be arranged as multiple individual sensor strips 704 extending along the shelving units and/or base of the storage containers, defining a sensing grid or matrix. The array of sensors 700 can be built into the shelving units and/or base of the storage containers itself or may be incorporated into a liner or mat disposed at the shelving units and/or base of the storage containers. Although the array of sensors 700 is shown as arranged to form a grid, the array of sensors can be disposed in other various ways. For example, the array of sensors 700 may also be in the form of lengthy rectangular sensor strips extending along either the x-axis or y-axis. The array of sensors 700 can detect attributes associated with the physical objects that are stored on the shelving units and/or the storage containers, such as, for example, detecting pressure or weight indicating the presence or absence of physical objects at each individual sensor 702. In some embodiments, the surface of the shelving unit is covered with an appropriate array of sensors 700 with sufficient discrimination and resolution so that, in combination, the sensors 702 are able to identify the quantity, and in some cases, the type of physical objects in the storage container or shelving units.

In some embodiments the array of sensors 700 can be disposed along a bottom surface of a storage container and can be configured to detect and sense various characteristics associated with the physical objects stored within the storage container. The array of sensors can be built into the bottom surface of the tote or can be incorporated into a liner or mat disposed at the bottom surface of the mat.

The array of sensors 700 may be formed of a piezoelectric material, which can measure various characteristics, including, for example, pressure, force, and temperature. While piezoelectric sensors are one suitable sensor type for implementing at least some of the sensor at the shelving units and/or in the containers, exemplary embodiments can implement other sensor types for determine attributes of physical objects including, for example, other types of pressure/weight sensors (load cells, strain gauges, etc.).

The array of sensors 700 can be coupled to a radio frequency identification (RFID) device 706 with a memory having a predetermined number of bits equaling the number of sensors in the array of sensors 700 where each bit corresponds to a sensor 702 in the array of sensors 700. For example, the array of sensors 700 may be a 16×16 grid that defines a total of 256 individual sensors 702 may be coupled to a 256 bit RFID device such that each individual sensor 702 corresponds to an individual bit. The RFID device including a 256 bit memory may be configured to store the location information of the shelving unit and/or tote in the facility and location information of merchandise physical objects on the shelving unit and/or tote. Based on detected changes in pressure, weight, and/or temperature, the sensor 702 may configure the corresponding bit of the memory located in the RFID device (as a logic “1” or a logic “0”). The RFID device may then transmit the location of the shelving unit and/or tote and data corresponding to changes in the memory to the computing system.

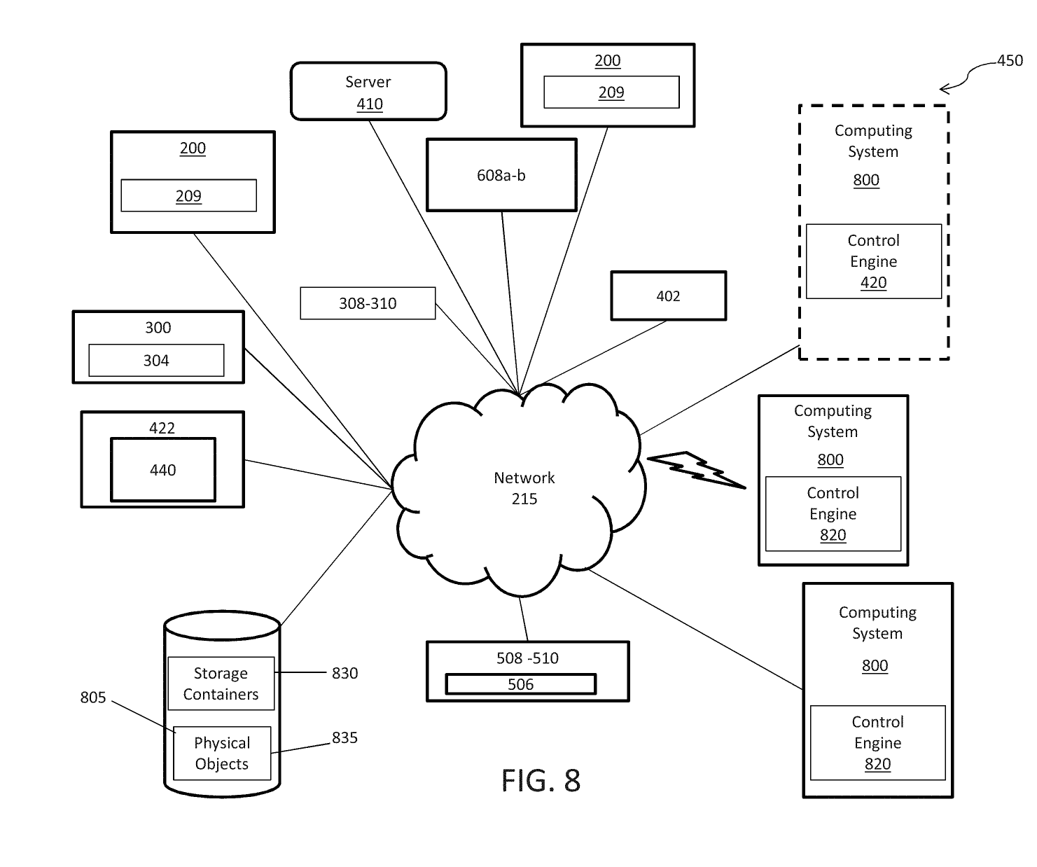

FIG. 8 illustrates an exemplary virtual reality autonomous fulfillment system in accordance with an exemplary embodiment. The virtual reality autonomous fulfillment system 850 can include one or more databases 805, one or more servers 810, one or more computing systems 800, one or more virtual reality headsets 200, one or more inertial sensors 300, one or more sensory feedback devices 308-310, sensors 440 disposed on shelving units 422, sensors 506 disposed in storage containers 508-510 and conveyer belts 608a-b. In exemplary embodiments, the computing system 800 is in communication with one or more of the databases 805, the server 810, the virtual reality headsets 200, the inertial sensors 300, the sensory feedback devices 308-310, the sensors 440 disposed on shelving units 422, the sensors disposed in storage containers 442 and the conveyer belts 608a-b, via a communications network 815. The computing system 800 can execute one or more instances of the control engine 820. The control engine 820 can be an executable application residing on the computing system 800 to implement the virtual reality fulfillment system 850 as described herein.

In an example embodiment, one or more portions of the communications network 815 can be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

The computing system 800 includes one or more computers or processors configured to communicate with the databases 805, the server 810, the virtual reality headsets 200, the inertial sensors 300, the sensory feedback devices 308-310 the sensors 440 disposed on shelving units 422, the sensors disposed in storage containers 442 and the conveyer belts 608a-b, via the network 815. The computing system 800 hosts one or more applications configured to interact with one or more components of the virtual reality fulfillment system 850. The databases 805 may store information/data, as described herein. For example, the databases 805 can include a physical objects database 835 can store information associated with physical objects. The databases 805 also include a storage containers database 830 which stores information associated with storage containers 508-510. The databases 805 and server 810 can be located at one or more geographically distributed locations from each other or from the computing system 800. Alternatively, the databases 805 can be included within server 810 or computing system 800.

In one embodiment, a user using an optical scanning device (as shown in FIG. 1) can scan a machine-readable element associated with a physical object or can select a simulated representation of the physical object in the 3D virtual simuation environment. The machine-readable element can include a identifier associated with the physical object. The optical scanning device can transmit the identifier to the computing system 800. The computing system 800 can execute the control engine 820 in response to receiving the identifiers or the selection of the simulated representation. The control engine 820 can query the physical objects database 835 using the received identifier to retrieve information associated with the physical object. The information can include, an image, size, color dimensions, weight, mass, density, texture, operation requirements, ideal operating conditions and responsiveness to environmental conditions. The control engine 820 can also retrieve information associated with additional physical objects associated with the physical object The control engine 820 can build or update the 3D virtual simulation environment to include the simulated representation of the physical object in an ideal operational environment in which the user can simulate the use of the physical object. The 3D virtual simulation environment can also include a simulated representations of the additional physical objects associated with the physical object. The control engine 220 can build the simulated representation of the physical object and the additional physical object based on the retrieved information.

The control engine 820 can instruct the virtual reality headset to display the 3D virtual simulation environment including the simulated representation of the physical object and the simulated representations of the additional physical objects. Alternatively, the control engine 820 can instruct the virtual reality headset 200 to display the 3D virtual simulation environment including the simulated representation of the physical object and display all or some of the simulated representations of the additional physical objects on the side panel (as discussed with reference to FIG. 2B). The size of the images of the simulated representations of the additional physical objects can be reduced when displayed on the side panel. The virtual reality headset 200 can detect motion of a user's head via, the inertial sensors 209 and/or detect motion of a user's hands or other body parts via the inertial sensors 300, to interact with the 3D virtual simulation environment. The virtual reality headset 200 can adjust the view on the display of the 3D virtual simulation environment based on the motion of the head based on the movement detected by the inertial sensor 209. The virtual reality headset 200 can simulate interaction with the simulated representations of the physical object and additional physical objects based on movement of detected by the inertial sensors 300 disposed on one or more body parts of a user. The user can also scroll, zoom in, zoom out, change views and or move the 3D virtual simulation environment based on movement of the inertial sensors 300. The inertial sensors 300 can communicate with the virtual headset 200, via the controller 304.

The virtual reality headset 200 can also provide sensory feedback based on interaction with the 3D simulation environment, via the sensory feedback devices 308-310. The virtual reality headset 200 can instruct the sensory feedback devices 308-310 to output sensory feedback based on the user's interaction with the 3D simulation environment. The sensory feedback can include one or more of: weight, temperature, shape, texture, moisture, force, resistance, mass, density, size, sound, taste and smell. The sensory feedback can be affected by the environmental conditions and/or operation of the physical object in the 3D simulation environment. For example, a metal physical object can be simulated be get hot under the sun. The sensory feedback devices 308-310 can output an amount of heat corresponding to the metal of the physical object. In some embodiments, the user can select for different environmental conditions, such as weather, indoor or outdoor conditions. The control engine 820 can reconstruct the 3D simulation environment based on the user's selection and instruct the virtual reality headset 200 to display the reconstructed 3D virtual simulation environment.

The user can select the simulated representations of the additional physical objects displayed on the side panel to be included in the 3D virtual simulation environment. In response to being selected, the size of the simulated representation of the additional physical object can be enlarged and the simulated representation of the additional physical object can be included in the 3D virtual simulation environment.

The user can select the simulated representation of the physical object displayed in the 3D virtual simulation environment for autonomous retrieval from a facility. The user can select the simulated representations of the physical objects using user gestures. The virtual reality headset 200 can detect the selection via the inertial sensors 209 or 300. In response to selection of the simulated representations of the physical objects, the virtual reality headset 200 can transmit the identifiers associated with the physical objects along with information about the user to the computing system 800. The information can include, user name, user address, a requested delivery address and/or requested pick up location.

The computing system 800 can receive a request to retrieve physical objects disposed in one or more facilities from the virtual reality headset 200. The computing system 800 can execute the control engine 820 in response to receiving the request to retrieve the physical objects. The control engine 820 can query the physical objects database 835 to retrieve the locations of the requested physical objects within the one or more facilities. The control engine 820 can divide the requested physical objects into groups based one or more attributes associated with the requested physical objects. For example, the control engine 820 can group the requested physical objects based on the proximity between the locations of the physical objects on the shelving units 422 and/or can create groups of physical objects with shortest paths between the locations of the physical objects. In another example, the control engine 820 can divide the physical objects into groups based on the size of the physical objects or type of physical object. Each group can include requested physical objects from various requests.

The control engine 820 can assign one or more groups of requested physical object to different autonomous robotic device 402 disposed in the facility. The autonomous robotic device 402 can receive instructions from the control engine 820 to retrieve the one or more groups of physical objects and transport the physical objects to a location of the facility including various storage containers. The one or more groups of physical objects can include a predetermined quantity of physical objects from different sets of like physical objects. The instructions can include identifiers associated with the physical objects and identifiers associated with the storage containers. The instructions can include identifiers for various storage containers. The retrieved physical objects can be deposited in different storage containers based on attributes associated with the physical objects. The attributes can include: a delivery address of the physical objects, size of the physical objects and the type of physical objects. The autonomous robotic device 402 can query the physical objects database 835 to retrieve the locations of the physical objects in the assigned group of physical objects.

The autonomous robotic device 402 can navigate to the physical objects and scan a machine-readable element encoded with an identifier associated with each set of like physical objects. The autonomous robotic device 402 can decode the identifier from the machine-readable element and query the physical objects database 835 to confirm the autonomous robotic device 402 was at the correct location. The autonomous robotic device 402 can also retrieve stored attributes associated with the set of like physical objects in the physical objects database 835. The autonomous robotic device 402 can capture an image of the set of like physical objects and extract a set of attributes using machine vision and/or video analytics. The autonomous robotic device 402 can compare the extracted set of attributes with the stored set of attributes to confirm the set of like physical objects are same as the ones included in the instructions. The extracted and stored attributes can include, image of the physical objects, size of the physical objects, color of the physical object or dimensions of the physical objects. The types of machine vision and/or video analytics used by the control engine 820 can be but are not limited to: Stitching/Registration, Filtering, Thresholding, Pixel counting, Segmentation, Inpainting, Edge detection, Color Analysis, Blob discovery & manipulation, Neural net processing, Pattern recognition, Barcode Data Matrix and “2D barcode” reading, Optical character recognition and Gauging/Metrology. The autonomous robotic device 402 can pick up a specified quantity of physical objects in the one or more group of physical objects. In the event the autonomous robotic device 402 is an autonomous retrieving container, the autonomous robotic device 402 can navigate around the edges of the of the shelving unit 422 and retrieve the specified quantity of physical objects from the shelving unit 422.

In the event the autonomous robotic device 402 is an smart shelf autonomous storage and retrieval system. The autonomous robot device 260 can traverse along the edges of a smart shelving unit and retrieve the physical objects. The autonomous robotic device 402 can place the physical objects on the conveyer belt 608a disposed behind the smart shelving unit. The conveyer belts 608a can receive instructions from the control engine 820 to transport products to another conveyer belt 608b. The conveyer belt 608b can receive instructions to transport the products to a specified location in a facility such as a delivery vehicle or a loading area.

The autonomous robotic device 402 can carry the physical objects to a location of the facility including storage containers 508-510. The storage containers 508-510 can have machine-readable elements disposed on the frame of the storage containers. The autonomous robotic device 402 can scan the machine-readable elements of the storage containers and decode the identifiers from the machine-readable elements. The autonomous robotic device 402 can compare the decoded identifiers with the identifiers associated with the various storage containers included in the instructions. The autonomous robotic device 402 can deposit the physical objects from the one or more groups assigned to the autonomous robotic device 402 in the respective storage containers. For example, the autonomous robotic device 402 can deposit a first subset of physical objects from the one or more groups of physical objects in a first storage container 508 and a second subset of physical objects from one or more groups of physical objects in a second storage container 510 based on the instructions.

Sensors 440 can be disposed at the shelving unit 422 in which the requested physical objects are disposed. The sensors 440 disposed at the shelving unit 422 can transmit a first of attributes associated with the physical objects disposed on the shelving unit 422, encoded into electrical signals to the control engine 820 in response to the autonomous robotic device 402 picking up the physical objects from the shelving unit. The sensors 440 can be coupled to an RFID device. The RFID device can communicate the electrical signals to the control engine 820. The first set of attributes can be a change in weight, temperature and moisture on the shelving unit 422. The control engine 820 can decode the first set of attributes from the electrical signals. The control engine 820 can determine the correct physical objects were picked up from the shelving unit 422 based on the first set of attributes. For example, the physical objects can be perishable items. The autonomous robotic device 402 can pick up the perishable items, and based on the removal of perishable items, the sensors 440 disposed at the shelving unit 422 can detect a change in the moisture level. The sensors 440 can encode the change in moisture level in an electrical signals and transmit the electrical signals to the control engine 820. The control engine 820 can decode the electrical signals and determine the perishable items picked up by the autonomous robotic device 402 are damaged or decomposing based on the detected change in moisture level. The control engine 820 can send new instructions to the robotic device to pick up new perishable items and discard of the picked up perishable items.

The sensors 440 can also be disposed at the base of the storage containers 508-510. The sensors 440 disposed at the base of the storage containers 508-510 can transmit a second set of attributes associated with the physical objects disposed in the storage containers 508-510 to the control engine 820. The sensors 440 can be coupled to an RFID device. The RFID device can communicate the electrical signals to the control engine 820. The first set of attributes can be a change in weight, temperature and moisture in the storage containers 508-510. The control engine 820 can decode the first set of attributes from the electrical signals. The control engine 820 can determine whether the correct physical objects were deposited in the storage containers 508-510 based on the second set of attributes. For example, the sensors 440 disposed at the base of the storage containers 508-510 can detect an increase in weight in response to the autonomous robotic device 402 depositing an item in the storage container. The sensors 440 can encode the increase in weight in electrical signals and transmit the electrical signals to the control engine 820. The control engine 820 can decode the electrical signals and determine the an incorrect physical object was placed in the first storage container 508 based on the increase in weight. The control engine 820 can transmit instructions to the autonomous robotic device 402 to remove the deposited physical object from the first storage container 508. The control engine 820 can also include instructions to deposit the physical object in a different storage container.

As a non-limiting example, the virtual showroom system 250 can be implemented in a retail store. The virtual showroom system 250 can be used by customers to simulate the use of products disposed in the retail store. The customers can compare and contrast the products using the virtual showroom system 250. The customers can also purchase the products using the virtual reality headset 200 and request delivery or pickup. A user can scan using an optical scanning device, a machine-readable element associated with a product disposed in the retail store. The machine-readable element can include a identifier associated with the product. The optical scanner can transmit an identifier to the computing system 800. The computing system 800 can execute the control engine 820 in response to receiving the identifier. The control engine 820 can query the physical objects database 835 using the received identifier to retrieve information associated with the product. The information can include, an image, size, color dimensions, weight, mass, density, texture, operation requirements, ideal operating conditions, responsiveness to environmental conditions and brand. The control engine 820 can also retrieve information associated with additional product associated with the product. For example, the product can be a lawnmower, the control engine 820 can retrieve information associated with lawnmowers of various brands. The customer can set a table using various china, glasses and centerpieces. The customer can view the aesthetics of each of the products in isolation and/or in combination and can change out different products to change the table setting.

Furthermore, the control engine 820 can retrieve information associated with affinity products associated with lawnmower such as a hedge trimmer. The control engine 820 can build a 3D virtual simulation environment. The 3D virtual simulation environment can include a 3D rendering of the product in an ideal operational environment in which the user can simulate the use of the product. The 3D virtual simulation environment can also include a 3D rendering of the additional product associated with the product. For example in continuing with our example of the lawnmower, the 3D virtual simulation environment can include the selected lawnmower, lawnmowers of different brands and a hedge trimmer disposed in outdoors in a lawn with grass The control engine 820 can build the 3D rendering of the product and the additional product based on the retrieved information.

The control engine 220 can instruct the virtual reality headset to display the 3D virtual simulation environment including the product and the additional product. Alternatively, the control engine 820 can instruct the virtual reality headset 200 to display the 3D virtual simulation environment including the product and display all or some of the additional products on the side panel (as discussed with reference to FIG. 2B). The size of the images of the additional products can be reduced when displayed on the side panel. The virtual reality headset 200 can detect motion of a user's head via, the inertial sensors 209 and/or detect motion of a user's hands or other body parts via the inertial sensors 300, to interact with the 3D virtual simulation environment. The virtual reality headset 200 can adjust the view on the display of the 3D virtual simulation environment based on the motion of the head based on the movement detected by the inertial sensor 209. The virtual reality headset 200 can simulate interaction with the product and additional products based on movement of detected by the inertial sensors 300 disposed on one or more body parts of a user. For example, a user can simulate operating the lawnmower in the 3D virtual simulation environment. The lawnmower can move and operate according to the motion detected by inertial sensors 300. The user can also scroll, zoom in, zoom out, change views and or move the 3D virtual simulation environment based on movement of the inertial sensors 300. The inertial sensors 300 can communicate with the virtual headset 200, via the controller 304.

The virtual reality headset can also provide sensory feedback based on interaction with the 3D simulation environment, via the sensory feedback devices 308-310. The virtual reality headset 200 can instruct the sensory feedback devices 308-310 to output sensory feedback based on the user's interaction with the 3D simulation environment. The sensory feedback can include one or more of: weight, temperature, shape, texture, moisture, force, resistance, mass, density, size, sound, taste and smell. The sensory feedback can be affected by the environmental conditions and/or operation of the product in the 3D simulation environment. For example, a metal handle of the lawnmower can be simulated be get hot under the sun. The sensory feedback devices 308-310 can output an amount of heat corresponding to the metal handle of the lawnmower. The sensory feedback can also output the resistance of pushing the lawnmower and sensory feedback related to pushing the lawnmower uphill or downhill. In some embodiments, the user can select for different environmental conditions, such as weather, indoor or outdoor conditions. The control engine 820 can reconstruct the 3D simulation environment based on the user's selection and instruct the virtual reality headset 200 to display the reconstructed 3D virtual simulation environment. The user can compare and contrast the lawnmowers of different brands and/or the affinity products.

The user can select the simulated representations of the additional physical objects displayed on the side panel to be included in the 3D virtual simulation environment. In response to being selected, the size of the additional physical object can be enlarged and the simulated representations of the additional physical objects can be included in the 3D virtual simulation environment. The user can also pay for and checkout using the virtual reality headset 200. The user can interact with a payment/checkout screen displayed by the virtual reality headset 200. The virtual reality headset 200 can communicate with the control engine 820 so that the user can pay product displayed on in the 3D virtual simulation environment.

The customer can select the products displayed in the 3D virtual simulation environment for purchase and delivery and/or pick up. The customer can select the products, complete a purchase transaction for the product and request delivery and/or pick up of the products using user gestures. The virtual reality headset 200 can detect the selection via the inertial sensors 209 or 300. In response to purchase of the products, the virtual reality headset 200 can transmit the identifiers associated with the products along with information about the customer to the computing system 800. The information can include, user name, user address, a requested delivery address and/or requested pick up location.

The computing system 800 can receive instructions to retrieve products from a retail store based on a completed transaction at a physical or retail store. The computing system 800 can receive instructions from the virtual reality headsets 200. For example, the computing system 800 can receive instructions to retrieve products for various customers using the virtual reality headsets 200 from the virtual reality headset in response to a user gesture detected by the headset or the controller associated with the inertial sensors 300 corresponding to a selection of the simulated representations of the products in the virtual environment. The computing system 800 can execute the control engine 820 in response to receiving the instructions. The routing engine can query the physical objects database 835 to retrieve the location of the products in the retail store and a set of attributes associated with the requested products. The autonomous robotic device 402 can use location/position technologies including SLAM algorithms, LED lighting, RF beacons, optical tags, waypoints to navigate around the facility. The control engine 820 can divide the requested products into groups based on the locations of the products within the retail store and/or the set of attributes associated with the products. For example, the control engine 820 can divide the products into groups based on a location of the products, the priority of the products, the size of the products or the type of the products.

The control engine 820 can instruct the autonomous robotic device 402 to retrieve one or more groups of products in the retail store and transport the products to a location of the facility including various storage containers 508-510. The one or more groups of physical objects can include a predetermined quantity of physical objects from different sets of like physical objects. The instructions can include identifiers associated with the products and identifiers associated with the storage containers 508-510. The instructions can include identifiers for various storage containers 508-510. The retrieved products can be deposited in different storage containers 508-510 based on attributes associated with the products. The attributes can include: a delivery address of the products, priority assigned to the products, size of the products and the type of products. The autonomous robotic device 402 can query the physical objects database 835 to retrieve the locations of the products in the assigned group of products. The autonomous robotic device 402 can navigate to the products and scan a machine-readable element encoded with an identifier associated with each set of like products. The autonomous robotic device 402 can decode the identifier from the machine-readable element and query the physical objects database 835 to confirm the autonomous robotic device 402 was at the correct location. The autonomous robotic device 402 can also retrieve stored attributes associated with the set of like products in the physical objects database 835. The autonomous robotic device 402 can capture an image of the set of like physical objects and extract a set of attributes using machine vision and/or video analytics. The autonomous robotic device 402 can compare the extracted set of attributes with the stored set of attributes to confirm the set of like products are same as the ones included in the instructions. The autonomous robotic device 402 can pick up the products in the group of physical objects.

In the event the autonomous robotic device 402 is a smart shelf autonomous storage and retrieval system. The autonomous robot device 260 can traverse along the edges of a smart shelving unit and retrieve the physical objects. The autonomous robotic device 402 can place the physical objects on the conveyer belt 608a disposed behind the smart shelving unit. The conveyer belts 608a can receive instructions from the control engine 820 to transport products to another conveyer belt 608b. The conveyer belt 608b can receive instructions to transport the products to a specified location in a facility such as a delivery vehicle or a loading area.

Sensors 440 can be integrated with the autonomous robotic device 402. The sensors 440 can be disposed on the grasping mechanism of the articulated arm of the autonomous robotic device 402. The sensors 440 can detect a set of attributes associated the products in response to picking up the products with the grasping mechanism of the articulated arm of the autonomous robotic device 402. The set of attributes can be one or more of, size, moisture, shape, texture, color and/or weight. The autonomous robotic device 402 can determine the one or more products is damaged or decomposing based on the set of attributes. For example, in the event the product is a perishable item, the autonomous robotic device 402 can determine whether the perishable item has gone bad or is decomposing. The autonomous robotic device 402 can discard the one or more products determined to be damaged or decomposing and the autonomous robotic device 402 can pick up one or more replacement products for the discarded products.

The autonomous robotic device 402 can transport the products to a location of the facility including storage containers 508-510. The storage containers 508-510 can have machine-readable elements disposed on the frame of the storage containers 508-510. The autonomous robotic device 402 can scan the machine-readable elements of the storage containers 508-510 and decode the identifiers from the machine-readable elements. The autonomous robotic device 402 can compare the decoded identifiers with the identifiers associated with the various storage containers 508-510 included in the instructions. The autonomous robotic device 402 can deposit the products from the group of products assigned to the autonomous robotic device 402 in the respective storage containers 508-510. For example, the autonomous robotic device 402 can deposit a first subset of products from the group of physical objects in a first storage container 508 and a second subset of products from the group of physical objects in a second storage container 510 based on the instructions. In some embodiments, the autonomous robotic device 402 can determine the one or more of the storage containers 508-510 is full or the required amount of products are in the storage containers 508-510. The autonomous robotic device 402 can pick up the storage containers 508-510 and transport the storage containers 508-510 to a different location in the facility. The different location can be a loading dock for a delivery vehicle or a location where a customer is located. In one example, the autonomous robotic device 402 can transfer items between them. e.g. multi-modal transport within the facility. For example, the autonomous robotic device 402 can dispense an item onto a conveyor which transfers to staging area where an aerial unit picks up for delivery. In another embodiment the autonomous robotic device 402 can be an autonomous shelf dispensing unit. The shelf dispensing unit can dispense the items into the storage containers. A autonomous robotic device 402 can pick up the storage containers and transport the storage containers to a location in the facility.

Sensors 440 can be disposed at the shelving unit 422 in which the requested products are disposed. The sensors 440 disposed at the shelving unit 422 can transmit a first of attributes associated with the products encoded in electrical signals to the control engine 820 in response to the robotic device picking up the products from the shelving unit 422. The first set of attributes can be a change in weight, temperature and moisture on the shelving unit 422. The control engine 820 can decode the first set of attributes from the electrical signals. The control engine 820 can determine the correct products were picked up from the shelving unit 422 based on the first set of attributes. For example, the products can be perishable items. The autonomous robotic device 402 can pick up the perishable items and based on the removal of perishable items, the sensors 440 disposed at the shelving unit 422, can detect a change in the moisture level. The sensors 440 can encode the change in moisture level in an electrical signals and transmit the electrical signals to the control engine 820. The change in moisture can indicate a damaged, decomposing or un-fresh perishable items (i.e. brown bananas). The control engine 820 can decode the electrical signals and determine the perishable items picked up by the autonomous robotic device 402 are damaged or decomposing based on the detected change in moisture level. The control engine 820 can send new instructions to the robotic device to pick up new perishable items and discard of the picked up perishable items. For example, the control engine 820 can launch a web application for a user such as the customer and/or associate at the retail store to monitor which perishable items are picked up.

The sensors 440 can also be disposed at the base of the storage containers 508-510. The sensors 440 disposed at the base of the storage containers 508-510 can transmit a second set of attributes associated with the products disposed in the storage containers 508-510 to the control engine 820. The first set of attributes can be a change in weight, temperature and moisture in the storage containers 508-510. The control engine 820 can decode the first set of attributes from the electrical signals. The control engine 820 can determine whether the correct products were deposited in the storage containers 508-510 based on the second set of attributes. For example, the sensors 440 disposed at the base of the storage containers 508-510 can detect an increase in weight in response to the autonomous robotic device 402 depositing a product in the storage container 232. The sensors 440 can encode the increase in weight in electrical signals and transmit the electrical signals to the control engine 820. The control engine 820 can decode the electrical signals and determine the an incorrect product was placed in the storage container 508 based on the increase in weight. The control engine 820 can transmit instructions to the autonomous robotic device 402 to remove the deposited product from the storage container 508. The control engine 820 can also include instructions to deposit the product in a different storage container 510 or discard of the product.

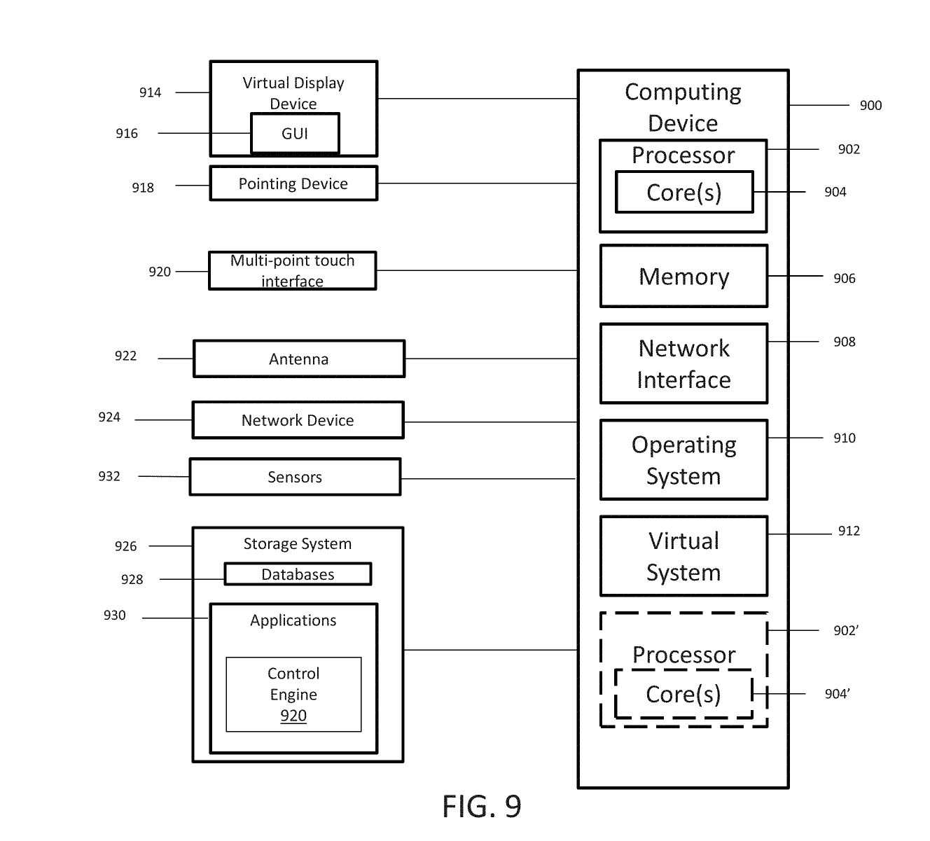

FIG. 9 is a block diagram of an exemplary computing device suitable for implementing embodiments of the automated shelf sensing system. The computing device 900 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives, one or more solid state disks), and the like. For example, memory 906 included in the computing device 900 may store computer-readable and computer-executable instructions or software (e.g., applications 930 such as the control engine 820) for implementing exemplary operations of the computing device 900. The computing device 900 also includes configurable and/or programmable processor 902 and associated core(s) 904, and optionally, one or more additional configurable and/or programmable processor(s) 902′ and associated core(s) 904′ (for example, in the case of computer systems having multiple processors/cores), for executing computer-readable and computer-executable instructions or software stored in the memory 906 and other programs for implementing exemplary embodiments of the present disclosure. Processor 902 and processor(s) 902′ may each be a single core processor or multiple core (904 and 904′) processor. Either or both of processor 902 and processor(s) 902′ may be configured to execute one or more of the instructions described in connection with computing device 900.

Virtualization may be employed in the computing device 900 so that infrastructure and resources in the computing device 900 may be shared dynamically. A virtual machine 912 may be provided to handle a process running on multiple processors so that the process appears to be using only one computing resource rather than multiple computing resources. Multiple virtual machines may also be used with one processor.

Memory 906 may include a computer system memory or random access memory, such as DRAM, SRAM, EDO RAM, and the like. Memory 906 may include other types of memory as well, or combinations thereof. The computing device 900 can receive data from input/output devices such as, a reader 932.

A user may interact with the computing device 900 through a visual display device 914, such as a computer monitor, which may display one or more graphical user interfaces 916, multi touch interface 920 and a pointing device 918.

The computing device 900 may also include one or more storage devices 926, such as a hard-drive, CD-ROM, or other computer readable media, for storing data and computer-readable instructions and/or software that implement exemplary embodiments of the present disclosure (e.g., applications such as the control engine 820). For example, exemplary storage device 826 can include one or more databases 928 for storing information regarding the physical objects and storage containers. The databases 928 may be updated manually or automatically at any suitable time to add, delete, and/or update one or more data items in the databases. The databases 928 can include information associated with physical objects disposed in the facility and the locations of the physical objects.

The computing device 900 can include a network interface 908 configured to interface via one or more network devices 924 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the computing system can include one or more antennas 922 to facilitate wireless communication (e.g., via the network interface) between the computing device 900 and a network and/or between the computing device 900 and other computing devices. The network interface 908 may include a built-in network adapter, network interface card, PCMCIA network card, card bus network adapter, wireless network adapter, USB network adapter, modem or any other device suitable for interfacing the computing device 900 to any type of network capable of communication and performing the operations described herein.

The computing device 900 may run any operating system 910, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device 900 and performing the operations described herein. In exemplary embodiments, the operating system 910 may be run in native mode or emulated mode. In an exemplary embodiment, the operating system 910 may be run on one or more cloud machine instances.

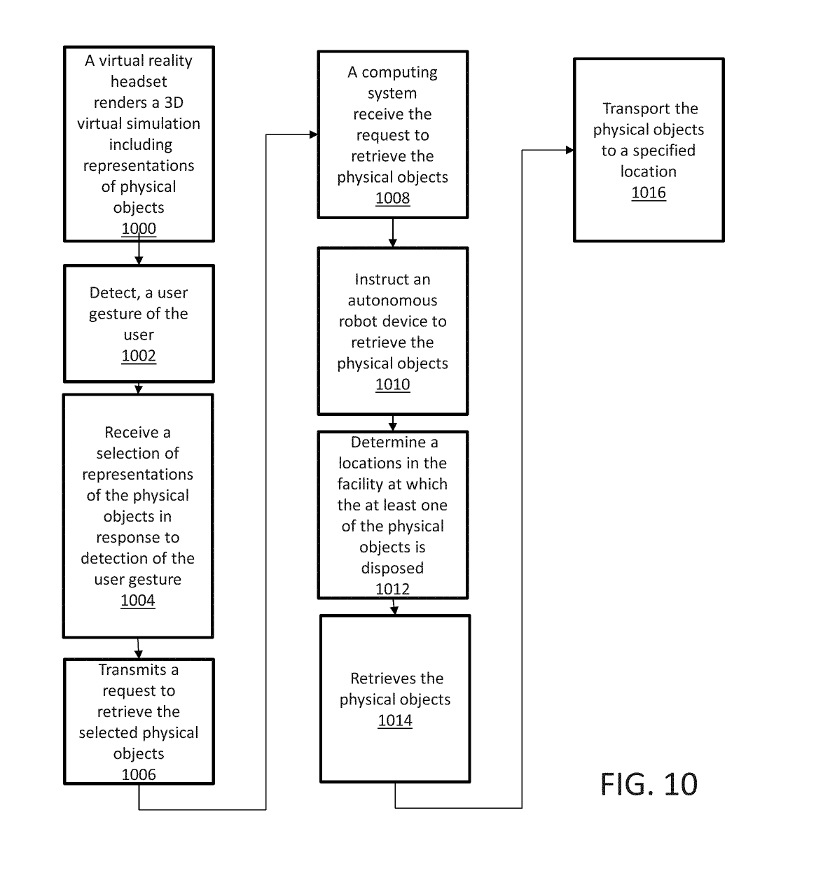

FIG. 10 is a flowchart illustrating a process of the virtual reality autonomous fulfillment system according to an exemplary embodiment. In operation 1000, a virtual reality headset (e.g. virtual reality headset 200 as shown in FIGS. 2A and 8) can render a 3D virtual simulation (e.g. 3D virtual simulation environment 212 as shown in FIG. 2B) environment on the display. The virtual reality headset can include inertial sensors (e.g. inertial sensors 209 as shown in FIGS. 2A and 9 the 3D). The 3D virtual simulation environment including simulated representations of physical objects (e.g. physical objects 102, 214, 216 as shown in FIG. 2B). In operation 1002, the inertial sensors can detect, a user gesture of the user. The user gesture corresponds to an interaction between the user and at least one of the simulated representations of the physical objects. In operation 1004, the virtual reality headset receives a selection of the at least one of the simulated representations of the physical objects in response to detection of the user gesture. In operation 1006, the virtual reality headset transmits a request to retrieve at least one of the physical objects corresponding to the at least one of the simulated representations from a facility (e.g. facility 400 as shown in FIG. 4). In operation 1008, a computing system (e.g. computing system 800 as shown in FIG. 8) can receive the request to retrieve the set of physical object disposed in the facility. In operation 1010 the computing system can instruct an autonomous robot device (e.g. autonomous robot device 402 as shown in FIGS. 4, 5 and 8) to retrieve the at least one of the physical objects (e.g. physical objects 424-430 as shown in FIG. 4). In operation 1012, the autonomous robot devices, determines a locations in the facility at which the at least one of the physical objects is disposed. In operation 1014, the autonomous robot device, autonomously retrieves the at least one of the physical objects. In operation 1016, the autonomous robot device transports, the at least one of the physical objects to a specified location in the facility at which the user can retrieve the at least one of the physical objects.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a multiple system elements, device components or method steps, those elements, components or steps may be replaced with a single element, component or step Likewise, a single element, component or step may be replaced with multiple elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the present disclosure. Further still, other aspects, functions and advantages are also within the scope of the present disclosure.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

We claim:

1. A virtual reality based fulfillment system, the system comprising:
a virtual reality headset including a plurality of inertial sensors and a display, configured to:
render a 3D virtual simulation environment on the display, the 3D virtual simulation environment including simulated representations of physical objects;
detect a user gesture of the user using at least one of the plurality of inertial sensors, the user gesture corresponding to an interaction between the user and at least one of the simulated representations of the physical objects;
receive a selection of the at least one of the simulated representations of the physical objects in response to detection of the user gesture; and
transmit a request to retrieve at least one of the physical objects corresponding to the at least one of the simulated representations from a facility;
a computing system in communication with the virtual reality headset, the computing system programmed to:
receive the request to retrieve the set of physical object disposed in the facility; and
instruct at least one of a plurality of autonomous robot devices in selective communication with the computing system via a communications network retrieve the at least one of the physical objects, wherein the at least one of the plurality of autonomous robot devices is configured to:
determine one or more locations in the facility at which the at least one of the physical objects is disposed;
autonomously retrieve the at least one of the physical objects; and
transport the at least one of the physical objects to a specified location in the facility at which the user can retrieve the at least one of the physical objects.

2. The system of claim 1, further comprising a database operatively coupled to the computing system and wherein the instructions from the computing system include one or more identifiers for the at least one of the physical objects and the at least one of the autonomous robot devices is configured to:
query the database using the one or more identifiers for the at least one of the physical objects to retrieve the one or more locations at which the at least one of the physical objects is disposed;
navigate autonomously through the facility to the one or more locations in response to operation of the drive motor by the controller;
locate and scan one or more machine readable elements encoded with the one or more identifiers;
detect, via at least one image captured by the image capture device, that the at least one of the physical objects is disposed at the one or more locations; and
pick up a quantity of the at least one of the physical objects using an articulated arm of the at least one of the autonomous robot devices.

3. The system in claim 2, further comprising a plurality of shelving units disposed in the facility and wherein the quantity of the at least one of the physical objects is disposed on at least one of the plurality of shelving units.

4. The system of claim 3, further comprising:
a first plurality of sensors disposed on or about the plurality of shelving units.

5. The system of claim 4, wherein the first plurality of sensors are configured to detect a change to a first set of attributes associated with the shelving units when the quantity of the at least one of the physical objects is removed from the at least one of the plurality of shelving units, and to transmit the first set of attributes to the computing system.

6. The system of claim 5, wherein the computing system updates the database in response to receiving the first set of attributes.

7. The system of claim 5, wherein the first set of attributes include one or more of: moisture, weight, quantity or temperature.

8. The system of claim 1, wherein at least one storage container is disposed at the specified location and the at least one of the autonomous robot further devices is configured to deposit the retrieved set of physical objects in the at least one storage container.

9. The system of claim 8, wherein the at least one of the autonomous robot further devices is configured to carry the storage container to the user of the virtual reality headset.

10. The system of claim 1, further comprising:
a controller configured to be held or worn on a hand of the user, the controlling including a second plurality of sensors,
wherein the user interacts with the controller to interact with or select the at least one of the simulated representations of the at least one of the physical objects.

11. The system of claim 1, wherein the virtual reality headset is configured to:
generate sensory feedback based on a first set of sensory attributes associated with the at least one physical object in response to executing the first action in the 3D virtual simulation environment.

12. The system of claim 11, wherein the virtual reality headset is further configured to:
render the 3D virtual simulation environment including the at least one physical object and additional physical objects associated with the first physical object on the display;
detect a second user gesture using at least one of the plurality of inertial sensors, the second user gesture corresponding to an interaction between the user and the 3D virtual simulation environment;
execute a second action in the 3D virtual simulation environment based on the second user gesture to provide a demonstrable property or function of the at least one of the additional physical objects; and
generate sensory feedback based on a second set of sensory attributes associated with the at least one of the additional physical objects in response to executing the second action in the 3D virtual simulation environment.

13. A method in virtual reality based fulfillment system, the method comprising:
rendering, via a virtual reality headset including a plurality of inertial sensors and a display, a 3D virtual simulation environment on the display, the 3D virtual simulation environment including simulated representations of physical objects;
detecting, via the inertial sensors of the virtual reality headset, a user gesture of the user using at least one of the plurality of inertial sensors, the user gesture corresponding to an interaction between the user and at least one of the simulated representations of the physical objects;
receiving, via the virtual reality headset, a selection of the at least one of the simulated representations of the physical objects in response to detection of the user gesture;
transmitting, via the virtual reality headset, a request to retrieve at least one of the physical objects corresponding to the at least one of the simulated representations from a facility;
receiving, via a computing system in communication with the virtual reality headset, the request to retrieve the set of physical object disposed in the facility; and
instructing, via the computing system, at least one of a plurality of autonomous robot devices in selective communication with the computing system via a communications network retrieve the at least one of the physical objects;
determining, via the at least one of the plurality of autonomous robot devices, one or more locations in the facility at which the at least one of the physical objects is disposed;
autonomously retrieving, the at least one of the plurality of autonomous robot devices, the at least one of the physical objects; and
transporting, the at least one of the plurality of autonomous robot devices, the at least one of the physical objects to a specified location in the facility at which the user can retrieve the at least one of the physical objects.

14. The method of claim 13, further comprising a and the at least one of the autonomous robot devices is configured to:
querying, via the at least one of the autonomous robot devices, a database operatively coupled to the computing system, using one or more identifiers for the at least one of the physical objects included in the instructions from the computing system, to retrieve the one or more locations at which the at least one of the physical objects is disposed;
navigating, via the at least one of the autonomous robot devices, autonomously through the facility to the one or more locations in response to operation of the drive motor by the controller;
locating, via the at least one of the autonomous robot devices and scan one or more machine readable elements encoded with the one or more identifiers;
detecting, via at least one image captured by the image capture device of the at least one of the autonomous robot devices, that the at least one of the physical objects is disposed at the one or more locations; and
picking, via the at least one of the autonomous robot devices, up a quantity of the at least one of the physical objects using an articulated arm of the at least one of the autonomous robot devices.

15. The method in claim 14, wherein the quantity of the at least one of the physical objects is disposed on at least one of a plurality of shelving units disposed in the facility.

16. The method of claim 15, further comprising:
detecting, via a first plurality of sensors disposed on or about the plurality of shelving units, a change to a first set of attributes associated with the shelving units when the first quantity of the at least one of the physical objects is removed from the at least one of the plurality of shelving units; and
transmitting, via the first plurality of sensors, the first set of attributes to the computing system.

17. The method of claim 16, wherein the first set of attributes include one or more of:
moisture, weight, quantity or temperature.

18. The method of claim 13, further comprising:
depositing, via the at least one of the autonomous robot further devices, the retrieved set of physical objects in at least one storage container; and
carrying, via the at least one of the autonomous robot further devices is configured to carry the storage container to the user of the virtual reality headset.

19. The method of claim 13, further comprising:
interacting with a controller configured to be held or worn on a hand of the user, the controlling including a second plurality of sensors, to interact with or select the at least one of the simulated representations of the at least one of the physical objects.

20. The method of claim 14, further comprising:
generating, via virtual reality headset, sensory feedback based on a first set of sensory attributes associated with the at least one physical object in response to executing the first action in the 3D virtual simulation environment;
rendering, via virtual reality headset, the 3D virtual simulation environment including the at least one physical object and additional physical objects associated with the first physical object on the display;
detecting, via virtual reality headset, a second user gesture using at least one of the plurality of inertial sensors, the second user gesture corresponding to an interaction between the user and the 3D virtual simulation environment;
executing, via virtual reality headset, a second action in the 3D virtual simulation environment based on the second user gesture to provide a demonstrable property or function of the at least one of the additional physical objects; and
generating, via virtual reality headset, sensory feedback based on a second set of sensory attributes associated with the at least one of the additional physical objects in response to executing the second action in the 3D virtual simulation environment.
